(19) United States
(12) Patent Application Publication
(10) Pub. No.: US 2026/0320018 A1
(43) Pub. Date: Oct. 15, 2026

(54) Multiplexed Embedding Tables for Improved Computational Efficiency

(71) Applicant: Google LLC, Mountain View, CA (US)

(72) Inventors: Wangcheng Kang, Santa Clara, CA (US); Benjamin Ray Coleman, Houston, TX (US); Zhiyuan Cheng, San Mateo, CA (US); Ed Huai-hsin Chi, Los Altos Hills, CA (US); Lichan Hong, Los Altos, CA (US); Matthew Fahrbach, Jersey City, NJ (US); Ruoxi Wang, Palo Alto, CA (US)

(21) Appl. No.: 19/485,246

(22) PCT Filed: May 17, 2024
(86) PCT No.: PCT/US2024/029948

§ 371 Date: Nov. 17, 2025

Related U.S. Application Data
(60) Provisional application No. 63/502,842, filed on May 17, 2023.

(51) Int. Cl. G06F 16/22

(52) U.S. Cl. CPC G06F 16/2255

(57) ABSTRACT

Provided are systems and methods for generating embedding tables that significantly improve computational efficiency. In particular, one aspect of the present disclosure is directed to the use of a multiplexed embedding table that provides an effective solution for handling embeddings for high-dimensional feature data in machine learning systems. Specifically, the multiplexed embedding table allows multiple features to share a single representation space. For example, in the multiplexed embedding table, at least two values that are respectively associated with at least two different features can be mapped to a shared vector (e.g., row) in the multiplexed embedding table.

### RELATED APPLICATIONS

This application claims priority to and the benefit of U.S. Provisional Patent Application No. 63/502,842 filed May 17, 2023. U.S. Provisional Patent Application No. 63/502,842 is hereby incorporated by reference in its entirety.

### FIELD

The present disclosure relates generally to machine learning. More particularly, the present disclosure relates to the use of a multiplexed embedding table for efficient and effective learning and storage of embeddings for high-dimensional feature data.

### BACKGROUND

In the field of machine learning, the term embeddings can refer to representations of feature data in a continuous vector space that can capture semantic relationships between individual items. Embeddings transform feature data (e.g., which can contain values for discrete, categorical variables) into continuous vectors of fixed dimensions.

An embedding table can refer to a data structure used to store the embeddings. Typically, each vector (e.g., row) in the embedding table can correspond to a specific feature value for a specific feature, and the columns of the table can represent the dimensions of the continuous vector space. The values in this table, known as embedding values, can be learned during a training process and can serve to encode the relationships between different features.

The concept of embeddings and embedding tables is important to numerous machine learning tasks. In particular, the effective and efficient learning of high-quality feature embeddings is a crucial aspect for large-scale systems that ingest hundreds of features with vocabularies in the range of millions to billions. These features are typically represented as d-dimensional vector embeddings, leading to an explosion of parameters for high-cardinality features.

This has become a significant bottleneck, inspiring substantial interest and advancements in alternative embedding algorithms. However, most of these methods still implicitly assume that each feature utilizes an independent embedding table.

### SUMMARY

Aspects and advantages of embodiments of the present disclosure will be set forth in part in the following description, or can be learned from the description, or can be learned through practice of the embodiments.

One example aspect of the present disclosure is directed to a computer-implemented method to generate embedding tables with improved computational efficiency. The method includes obtaining, by a computing system comprising one or more computing devices, a set of feature data that corresponds to one or more items, wherein the set of feature data comprises a plurality of values for each of a plurality of features. The method includes establishing, by the computing system, a multiplexed embedding table in which at least two of the values that are respectively associated with at least two different features of the plurality of features are mapped to a shared vector in the multiplexed embedding table. The method includes storing, by the computing system, a plurality of embeddings associated with the plurality of values in the multiplexed embedding table.

Another example aspect of the present disclosure is directed to a machine-learned model that processes an embedding retrieved from a multiplexed embedding table to generate a prediction.

Other aspects of the present disclosure are directed to various systems, apparatuses, non-transitory computer-readable media, user interfaces, and electronic devices.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, serve to explain the related principles.

### BRIEF DESCRIPTION OF THE DRAWINGS

Detailed discussion of embodiments directed to one of ordinary skill in the art is set forth in the specification, which makes reference to the appended figures, in which:

FIGS. 1A and 1B depict example multiplexed embedding tables according to example embodiments of the present disclosure.

FIG. 2 depicts a flow chart diagram of an example method to generate a multiplexed embedding table according to example embodiments of the present disclosure.

FIG. 3A depicts a block diagram of an example computing system according to example embodiments of the present disclosure.

FIG. 3B depicts a block diagram of an example computing device according to example embodiments of the present disclosure.

FIG. 3C depicts a block diagram of an example computing device according to example embodiments of the present disclosure.

Reference numerals that are repeated across plural figures are intended to identify the same features in various implementations.

### DETAILED DESCRIPTION

### Overview

The present disclosure provides systems and methods for generating embedding tables that significantly improve computational efficiency. In particular, one aspect of the present disclosure is directed to the use of a multiplexed embedding table that provides an effective solution for handling embeddings for high-dimensional feature data in machine learning systems. Specifically, the multiplexed embedding table allows multiple features to share a single representation space. For example, in the multiplexed embedding table, at least two values that are respectively associated with at least two different features can be mapped to a shared vector (e.g., row) in the multiplexed embedding table.

More particularly, a computing system implementing the present disclosure can obtain a set of feature data. The feature data may originate from a singular database, application, or platform, or it may need to be sourced from a multitude of production systems, each possibly possessing different data structures, vocabularies, and quality standards.

This feature data can correspond to one or more items and can include multiple values for each of several features, such as categorical features. For example, each categorical feature can include one or more values v drawn from a vocabulary of the feature V. For each feature, the computing system can seek to embed the values into a space that is more suitable for modeling, such as, for example, [symbol] or the unit (d−1)-sphere. Given a vocabulary of N values V={v₁, v₂, . . . v_{N}}, the computing system can operate to learn a transformation that maps v∈V to an embedding vector e∈ [symbol] .

In particular, once the feature data set is obtained, the computing system can establish a multiplexed embedding table. According to an aspect of the present disclosure, the multiplexed embedding table can provide the capacity for feature multiplexing. As an example, the multiplexed embedding table can allow at least two values, each associated with different features, to be mapped to a shared vector in the table. This concept of feature multiplexing is a notable departure from traditional methods, which typically require separate embedding tables for each feature.

In some implementations, to establish the multiplexed embedding table, the computing system can use a hash function that maps the plurality of values for each feature to the vectors of the multiplexed embedding table. This can assist in creating the unified representation space, as it allows for efficient allocation of feature values to the table vectors. In some implementations, the hash function(s) used in this process is permitted to generate inter-feature collisions. This means that different feature values can be mapped to the same vector in the embedding table, thereby causing the feature multiplexing. As one example, the hash function employed in the establishment of the multiplexed embedding table can be a 2-universal hash function, which provides desirable properties for efficient mapping and controlled collision rates in the shared representation space.

The multiplexed embedding table provides improved computational efficiency. The shared vector within the table allows for a significant reduction in the number of required embeddings. In conventional methods, each feature value would be represented by a unique embedding. However, with the multiplexed table, a single table vector can correspond to multiple feature values, significantly reducing the total number of embeddings needed.

Following the establishment of the multiplexed embedding table, the computing system can generate (e.g., learn) and store a number of embeddings within the table. As described above, these embeddings can be machine-readable representations of the feature data and can be used for the downstream operation of machine learning models such as classifiers, recommendation systems, etc. The storage of embeddings in the multiplexed table represents a significant computational saving over traditional methods.

In particular, one advantage of the proposed approach is the dramatic improvement in computational efficiency. By reducing the number of necessary embeddings, the proposed technique lessens the computational load associated with managing high-dimensional feature spaces. Furthermore, as shown in the attached Appendix, the multiplexing approach does not compromise the quality or integrity of the feature embeddings. Despite sharing a common representation space, machine learning algorithms can still differentiate between different feature values. This capability is valuable for the practical application of the proposed table in diverse machine learning contexts.

Furthermore, the proposed solution can also be extended to variable-length embeddings, which is particularly beneficial for use cases where different features necessitate different embedding dimensions. In this embodiment, the final embedding can be obtained by concatenating the results of a variable number of table lookups. As one example, if there are three features requiring embedding dimensions of 8, 16, and 64, these features can be decomposed into three unified tables of dimensions 8, 8, and 48 respectively. All features index into the first table, the last two features use the second table, and only the final feature utilizes the 48-dimensional table. However, another option that exhibits similar performance includes maintaining a single table of dimension 8 and performing 1, 2, and 8 lookups. This flexible method ensures that the desired sizes can be obtained by concatenating the lookups along the dimension axis.

The proposed solution can also be extended to handle the concept of shared vocabularies, which is particularly useful when dealing with categorical feature vocabularies that overlap. One example of such an overlap is in two features representing character bigrams of different text fields. One possible strategy is to use distinct hash functions for each feature by altering the hash seed or salt. However, in some embodiments, it has been observed that performance improves when the same hash function or mapping is utilized for multiple features. Some embodiments of the proposed solution employ this strategy, treating the decision to use the same or different hash mappings as a hyperparameter. This enables the solution to effectively manage overlapping feature vocabularies while optimizing performance, further enhancing the versatility and adaptability of the multiplexed embedding table approach.

The systems and methods of the present disclosure provide a number of technical effects and benefits. As one example, the multiplexing approach has the technical effect of drastically reducing the number of required embeddings. In contrast to traditional methods, which need a unique embedding for each feature value, the multiplexed table allows multiple feature values to be mapped to a shared vector. This leads to substantial computational efficiency, thereby reducing the processing power and memory requirements of the machine learning system. However, the proposed solution retains the ability to distinguish between different features despite their sharing a common representation space. This ensures that the quality and accuracy of the machine learning process are not compromised, even as the computational efficiency is significantly improved.

As another example technical effect, the proposed techniques enable reduced database complexity. In particular, instead of maintaining separate embedding tables for each feature, all features are represented in a single, unified table. This simplification of the database structure reduces complexity, making it easier to manage and maintain. One benefit of this reduced complexity is a lower query cost. With traditional approaches, querying the embeddings of multiple features would involve accessing several different tables, each with its own indexing and retrieval cost. However, with the multiplexed table, all features can be queried from a single location, reducing the overall cost of database operations and also latency associated with database queries or lookup operations.

The proposed solution presents several technical advantages with respect to integration with hardware accelerators such as Graphics Processing Units (GPUs) and Tensor Processing Units (TPUs), which are essential for efficient computation in large-scale machine learning tasks. For example, the multiplexed embedding table approach substantially reduces the number of parameters compared to standard approaches that require separate embedding tables for each feature. More particularly, current hardware accelerators are already optimized for row lookups from embedding tables. By maintaining the row-vector lookup paradigm (e.g., as compared to other advanced approaches that perform dimension- or column-specific lookups) the proposed techniques can achieve the full benefits of the hardware accelerators and also benefit from any further advance in this direction. Furthermore, the multiplexed embedding approach allows for better utilization of the parallel processing capabilities of GPUs and TPUs. Since multiple feature values are mapped to the same vector in the table, the same computations can be reused for different features, reducing the total amount of computation and enabling faster processing times. Likewise, because embeddings are retrieved from a single table, rather than multiple, the proposed approach can eliminate situations where one table of multiple tables are unavailable. Therefore, when hardware accelerators are performing operations on batches of embeddings, the full parallelizability of the batch can be performed. That is, by avoiding situations where one table of multiple tables are unavailable, the proposed approach can avoid situations where the full parallelizability of a hardware accelerator over a batch of data is not utilized.

The proposed multiplexed embedding table approach can be applied to a broad range of use cases. As one example, given the high-dimensional nature of language data, the proposed solution can be beneficial in generating efficient word embeddings for large vocabularies. It can be applied to tasks such as sentiment analysis, machine translation, and topic modeling, where the method's ability to handle variable-length embeddings could be especially useful. As another example, the multiplexed embedding table approach can be applied to handle the high cardinality categorical features often seen in recommendation systems. As another example, the proposed solution can be used for handling high-dimensional categorical metadata associated with the images. This can improve the efficiency of large-scale image classification or object detection tasks. As yet another example, the proposed solution can be applied in the field of genomics, where data can be both high-dimensional and sparse. For example, the proposed solution could be used to create efficient embeddings for genetic sequences. As another example, the proposed technique can be applied to social network data, where nodes (users) and edges (relationships) can be treated as high cardinality categorical features.

Another example aspect of the present disclosure is directed to a computing system that includes a machine-learned model. This model is designed to process an embedding retrieved from the multiplexed embedding table, as described herein. Once the relevant embedding is retrieved from the table, it can be provided as an input to the machine-learned model. The model can then employ its learned parameters to process this input, effectively leveraging the condensed and meaningful information contained within the embedding. The output of the model can be a prediction, which can be interpreted and utilized in various ways depending on the specific application of the machine learning system.

Example embodiments of the present disclosure will be discussed in further detail.

### Example Settings

Various applications present supervised learning problems over categorical (sparse) features that represent properties of users, queries, and items. Some examples are search, content serving, and recommendation systems. Each categorical feature can include one or more feature values v drawn from the vocabulary of the feature V. For a concrete example, consider the classic click-through rate (CTR) prediction task for content serving systems, where we want to predict the probability of a user clicking on a particular item of content. The “content_id” feature may take on hundreds of billions of possible values—one for each unique item of content served by the platform—while “site_id” describes the website where that item of content was shown (a.k.a., the publisher).

Some example implementations can embed the values of each feature into a space that is more suitable for modeling, e.g., [symbol] or the unit (d−1)-sphere. Given a vocabulary of N tokens V={v₁, v₂, . . . , v_{N}}, example implementations can learn a transformation that maps v∈V to an embedding vector e∈ [symbol] . After repeating this process for each categorical feature, a set of embeddings is generated that are then concatenated and fed as input to a neural network.

### Example Problem

A computing system can obtain a dataset D={(x₁, y₁), (x₂, y₂), . . . , (X_{|D|}, y_{|D|})} of examples with labels. The examples can include values from T different categorical features with vocabularies {V₁, V₂, . . . , V_{T}}, where feature t has vocabulary Vₜ. The notation is this description relates to the setting that each example x has one value for each categorical feature, i.e., x=[v₁, v₂, . . . , v_{T}] where vᵢ∈Vᵢ. However, this is for notational convenience only—the techniques described herein extend to missing and multivalent feature values as well.

Formally, the embedding table is a matrix E∈ [symbol] and the embedding function g(x; E) transforms the categorical feature values into embeddings. Let h(v): V→[M] be, for example, a 2-universal hash function that assigns a feature value to a row index of the embedding table. Also consider a model function ƒ(e;θ) that transforms the concatenated embeddings into a model prediction, which is penalized by a loss [symbol] . Using this decomposition, some example implementations can define the joint feature learning problem as follows:

$$arg {min}_{E , θ} {ℒ}_{D} ( E , θ ) , where {ℒ}_{D} ( E , θ ) = {\sum }_{( x , y ) ∈ D} ℓ ( f ( g ( x ; E ) ; θ ) , y ) . \qquad ( 1 )$$

Some example implementations can use independent hash functions hₜ(v) for each feature t∈[T] so that tokens appearing in multiple vocabularies have the chance to get mapped to different locations, depending on the feature. This description uses the notation eₘ to denote the m-th row of E, which means eₕ₍ᵤ₎ is the embedding of u. Lastly, let [symbol] _{u,v} be the indicator variable that denotes a hash collision between u and v, i.e., h(u)=h(v).

### Example Feature Multiplexing

In some settings, it is typical practice to use a different hash table for each categorical feature. There are a few approaches that deviate from this common practice—for example, HashedNet and ROBE-Z models use parameter sharing across all features, depending on the implementation. However, conventional wisdom suggests that each categorical vocabulary benefits from having an independent representation, so shared representations are not well-studied.

### Example Parameter Reuse:

One example aspect of the present disclosure is directed to a Feature Multiplexing framework that only uses one embedding table to represent all of the feature vocabularies. In contrast, typical models in prior systems have hundreds of embedding tables, each representing one input feature. Multiplexed embeddings allow models to reuse parameters and lookup operations, improving efficiency in terms of both space and time. This is beneficial for models that must fit into limited GPU/TPU memory or satisfy latency and serving cost constraints. In principle, any feature embedding scheme (e.g., hashing trick, multihash, compositional, or ROBE-Z) can be used as the shared representation for feature multiplexing. Some example implementations use a multi-size (multi-probe) version of the multiplexed feature hashing trick, which can be referred to as Unified Embedding. Unified Embedding presents unique practical advantages.

### Example Tunable Embedding Width:

By using a unified table, some example implementations make the architectural assumption that all features share the same embedding dimension. However, this is often sub-optimal in practice since independent tuning of individual embedding dimensions can significantly improve model performance. For use-cases where different features require different embedding dimensions, some example implementations can concatenate the results of a variable number of table lookups to obtain the final embedding. While this limits the output dimension to multiples of the table dimension, this is not a limiting constraint (and is needed by other methods such as ROBE-Z and product quantization).

### Example Shared Vocabulary:

In some settings, categorical feature vocabularies can share tokens. For example, two features that represent character bigrams of different text fields (e.g., query and document) might have substantial overlap. Some example implementations can use a different hash function for each feature by using a different hash seed for each feature. However, in cases where many semantically-similar features are present, the performance may slightly improve by using the same hash function.

### Example Analysis of Feature Multiplexing

This section analyses the example setting in which feature multiplexing is applied to the “multiplexed feature hashing trick” setting. The section starts with a brief analysis in the dimension-reduction framework, suggesting that multiplexing can optimally load balance feature vocabularies across buckets in the table. This classic framework, however, cannot be used to distinguish between collisions that happen within the vocabulary of a feature (i.e., intra-feature) and those occurring across features (i.e., inter-feature).

To understand these interactions, consideration should be given to the learning task and model training. Thus, the gradient updates applied to each bucket are analyzed under a simplified but representative model-binary logistic regression with learnable feature embeddings for CTR prediction. The analysis demonstrates a novel relationship between the embedding parameters and model parameters during gradient descent. Specifically, the effect of inter-feature collisions can be mitigated if the model projects different features using orthogonal weight vectors.

### Example Parameter Efficiency in the Dimension-Reduction Framework

In the feature hashing problem, we are given two vectors x, y∈ [symbol] that we project using a linear map φ: [symbol] → [symbol] given by the sparse {±1} matrix. The goal is for φ to minimally distort inner product, i.e., [symbol] φ(x), φ(y) [symbol] ≈(x, y). Since the estimation error directly depends on the variance, it is sufficient to compare hashing schemes based on the moments of their inner product estimators. This section examines the variance of the hashing trick and multiplexing trick.

To analyze multiple features at once in this framework, we consider the concatenations x=[x₁, x₂] and y=[y₁, y₂]. The components x₁∈{0,1}^{N}^{₁} and x₂∈{0,1}^{N}^{₂} are the one-hot encodings (or bag-of-words) for the two vocabularies V₁ and V₂. The standard hashing trick approximates (x, y) by independently projecting x₁ to dimension M₁ and x₂ to dimension M₂. The multiplexed version uses a single projection, but into dimension M₁+M₂. Now, we formalize the hashing trick, but with slightly revised notation. Given a set of tokens from the vocabulary, the embedding is the signed sum of value counts within each hash bucket.

Let h:V→{1, 2, . . . , M} be a 2-universal hash function and ξ: V→{−1, +1} be a sign hash function. The function φ_{h,ξ}:2^{V}→ [symbol] is defined as φ_{h,ξ}(W)=Σ_{w∈W}ξ(w)u_{h(w)}, where uᵢ is the i-th unit basis vector in [symbol] .

The following result compares multiplexed and standard embeddings in the dimension reduction framework. Note that the randomness is over the choice of hash functions h(v) and ξ(v). This result also directly extends to concatenating T feature embeddings.

For any x₁, y₁∈{0,1}^{N}^{₁} and x₂, y₂∈{0,1}^{N}^{₂}, let x=[x₁, x₂], y=[y₁, y₂] denote their concatenations. Let

$${μ}_{U} , {μ}_{H} , {σ}_{U}^{2} , and {σ}_{H}^{2}$$

be the mean and variance of [symbol] φ_{h,ξ}(x), φ_{h,ξ}(y) [symbol] for multiplexed and hash encodings, respectively. Then, μ_{U}=μ_{H}= [symbol] x, y [symbol] and

$${σ}_{U}^{2} = \frac{{‖ x ‖}_{2}^{2} {‖ y ‖}_{2}^{2} + {〈 x , y 〉}^{2} - 2 * 〈 x , y 〉}{{M}_{1} + {M}_{2}} ,$$

$${σ}_{H}^{2} = \frac{{‖ {x}_{1} ‖}_{2}^{2} {‖ {y}_{1} ‖}_{2}^{2} + {〈 {x}_{1} , {y}_{1} 〉}^{2} - 2 * 〈 {x}_{1} , {y}_{1} 〉}{{M}_{1}} + \frac{{‖ {x}_{2} ‖}_{2}^{2} {‖ {y}_{2} ‖}_{2}^{2} + {〈 {x}_{2} , {y}_{2} 〉}^{2} - 2 〈 {x}_{2} , {y}_{2} 〉}{{M}_{2}} .$$

The above analysis shows that multiplexed embeddings can do a good job balancing hash collisions across the parameter space. Consider the problem of estimating the inner product [symbol] x, y [symbol] . Suppose that

$${‖ {x}_{1} ‖}_{2}^{2} = {‖ {y}_{1} ‖}_{2}^{2} = {k}_{1} and {‖ {x}_{2} ‖}_{2}^{2} = {‖ {y}_{2} ‖}_{2}^{2} = {k}_{2} , i . e . ,$$

features 1 and 2 are multivalent with k₁ and k₂ values, and assume x and y are orthogonal, i.e., [symbol] x, y [symbol] =0. The analysis above tells us that

$${σ}_{U}^{2} = {( {k}_{1} + {k}_{2} )}^{2} / ( {M}_{1} + {M}_{2} ) and {σ}_{H}^{2} = {k}_{1}^{2} / {M}_{1} + {k}_{2}^{2} / {M}_{2} .$$

The difference

$${σ}_{H}^{2} - {σ}_{U}^{2}$$

factors as (\sqrt{M₁/M₂}k₁−\sqrt{M₂/M₁}k₂)²/(M₁+M₂), which is non-negative, implying

$${σ}_{U}^{2} \leq {σ}_{H}^{2} .$$

### Example Trajectories of Embeddings During SGD for Single-Layer Neural Networks

Inter-feature collisions are less problematic than intra-feature collisions. For example, if x∈V₁ collides with y∈V₂ but no other values collide across vocabularies, then the embeddings from other tokens in V₁ and V₂ are free to rotate around the shared embedding for x, y to preserve their optimal similarity relationships.

This section analyzes a logistic regression model with trainable embeddings for binary classification (i.e., a single-layer neural network with hashed one-hot encodings as input). This corresponds to Eq. 1 where ƒ(z; θ) is the sigmoid function σ_{θ}(z)=1/(1+exp(− [symbol] z, θ [symbol] )), is the binary cross-entropy loss, and y∈{0,1} (e.g., click or non-click). Some example implementations concatenate the embeddings of each feature, which means the input to ƒ(z; θ) is z=g(x; E)=[eₕ_{₁}₍ₓ_{₁}₎, eₕ_{₂}₍ₓ_{₂}₎, . . . , eₕ_{_{T}}_{(X)}_{_{T}}], where eₕ_{ₜ}₍ₓ_{ₜ}₎ is the embedding for the t-th feature value in example x. We write the logistic regression weights as θ=[θ₁, θ₂, . . . , θ_{T}] so that embedding eₕ_{ₜ}₍ₓ_{ₜ}₎ for feature t is projected via θₜ∈ [symbol] .

The following analysis holds in general for T features, but consider the problem for two categorical features with vocabularies V₁ and V₂ to simplify the discussion. We write the logistic regression objective as follows in Eq. 2, using C_{u,v,1} and C_{u,v,0} to denote the number of examples for which x=[u, v] and y=1 and y=0, respectively.

$${ℒ}_{D} ( E , θ ) = - {\sum }_{u ∈ {V}_{1}} {\sum }_{v ∈ {V}_{2}} {C}_{u , v , 0} log exp ( {θ}^{T} {e}_{u , v} ) - ( {C}_{u , v , 0} + {c}_{u , v , 1} ) log ( 1 + exp ( {θ}^{T} {e}_{u , ν} ) ) \qquad ( 2 )$$

To understand the effect of hash collisions on training dynamics, take the gradient with respect to eₕ_{₁}₍ᵤ₎, i.e., the embedding parameters that represent u∈V₁. By studying the gradients for collisionless, hash, and multiplexed embeddings, one can quantify the effects of intra-feature and inter-feature collisions. Interestingly, all three gradients can be written using the following three terms:

$${∇}_{{e}_{{h}_{1} ( u )}} {ℒ}_{D} ( E , θ ) = {θ}_{1} {\sum }_{v ∈ {V}_{2}} {C}_{u , v , 0} - ( {C}_{u , v , 0} + {C}_{u , v , 1} ) {σ}_{θ} ( {e}_{u , v} ) \qquad ( 3 )$$

$$+ {θ}_{1} {{\sum }_{w ∈ {V}_{1}}}_{w \neq u} {𝟙}_{u , w} {\sum }_{v ∈ {V}_{2}} {C}_{w , v , 0} - ( {C}_{w , v , 0} + {C}_{w , v , 1} ) {σ}_{θ} ( {e}_{u , v} ) \qquad ( 4 )$$

$$+ {θ}_{2} {\sum }_{v ∈ {V}_{2}} {𝟙}_{u , v} {\sum }_{w ∈ {V}_{1}} {C}_{w , v , 0} - ( {C}_{w , v , 0} + {C}_{w , v , 1} ) {σ}_{θ} ( {e}_{w , v} ) . \qquad ( 5 )$$

For collisionless embeddings, component (3) is the full gradient. For hash embeddings, the gradient is the sum of components (3) and (4). The multiplexed embedding gradient is the sum of all three terms.

One example observation is that embedding gradients can be decomposed into a collisionless (true) component (3), an intra-feature component (4), and an inter-feature component (5). The components from hash collisions act as a gradient bias. The intra-feature component is in the same direction as the true component, implying that intra-feature collisions are not resolvable by the model. This agrees with intuition since intra-feature hash collisions effectively act as value merging.

Inter-feature collisions, however, push the gradient in the direction of θ₂, which creates an opportunity for model training to mitigate their effect. To see this, consider a situation where θ₁ and θ₂ are initialized to be orthogonal and do not change direction during training. During SGD, the embedding eₕ_{₁}₍ᵤ₎ is a linear combination of gradients over the training steps, which means eₕ_{₁}₍ᵤ₎ can be decomposed into a true and intra-feature component, in the θ₁ direction, and an inter-feature component in the θ₂ direction. Since [symbol] θ₁, θ₂ [symbol] =0, the projection of

$${θ}_{1}^{T} {e}_{{h}_{1} ( u )}$$

effectively eleminates the inter-feature component.

These observations allow the formation of two expected behaviors. First, we expect the projection vectors [θ₁, θ₂, . . . , θ_{T}] to orthogonalize since this minimizes the effect of inter-feature collisions (and improves the loss). The orthogonalization effect should be stronger for embedding tables with fewer hash buckets since that is when inter-feature collisions are most prevalent. Second, intra-feature and inter-feature gradient contributions add approximately O(N/M) for each of their dimensions to the collisionless gradient since [symbol] [ [symbol] _{u,v}]=1/M. Therefore, we expect the squared embedding norms to scale roughly as O(N/M).

### Discussion of Features Sharing a Single Table

Returning to the parameter efficiency argument provided elsewhere herein, this section further describes the full benefits of feature multiplexing. The dimension reduction argument shows that, given a parameter budget, the multiplexed embedding has the same overall number of hash collisions as a well-tuned hash embedding. The gradient analysis, however, shows that not all collisions are equally problematic. Inter-feature collisions can be mitigated by a single-layer neural network because different features are processed by different model parameters. Shared embedding tables can work by load balancing unrecoverable collisions across a larger parameter space and effectively use one massive table for each feature.

### Example Multiplexed Embedding Tables

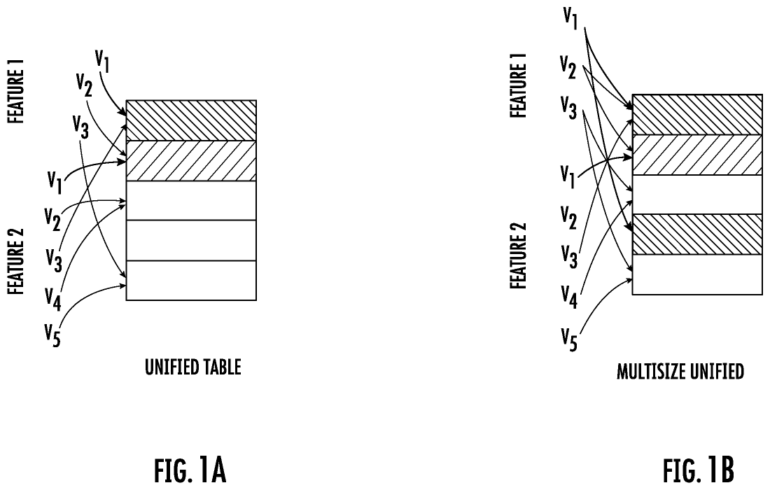

FIGS. 1A and 1B depict graphical diagrams illustrating example multiplexed embedding tables in the context of two categorical features.

Specifically, FIG. 1A depicts a unified table, which serves as a single representation space supporting both Feature 1 and Feature 2. In this configuration, the embeddings for each feature are merged within the table, enabling efficient storage and retrieval of feature values. The diagram highlights the lookup process for the first value, v1, of either feature. The unified table combines representations not only within each feature but also across features, leading to a comprehensive and unified embedding space.

In FIG. 1B, a multisize unified table is presented. This variation allows for embeddings of variable dimensions, accommodating features with different embedding requirements. In some implementations, to achieve this, the table can be divided into multiple sections or sub-tables, each dedicated to a specific dimension. However, as shown in FIG. 1B, in other implementations, certain feature values can be mapped to multiple vectors (e.g., rows) in the table. For example, in the diagram, the lookup process for the first value, v1, of Feature 1 demonstrates that the Feature 1, v1 has been indexed to multiple vectors. Therefore, retrieval of the embedding for Feature 1, v1 can include retrieval and combination (e.g., concatenation) of the embedding values from multiple different table vectors (e.g., rows). In contrast, Feature 2, v1 is mapped to only a single vector. Thus, the multisize unified table enables the creation of unified embeddings with varying dimensions.

### Example Methods

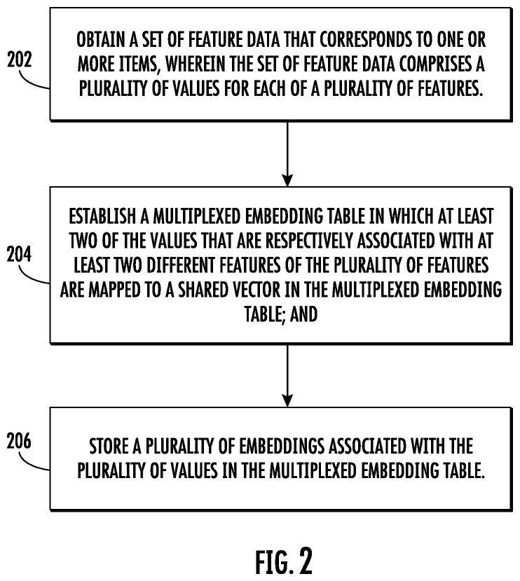

FIG. 2 depicts a flow chart diagram of an example method to perform according to example embodiments of the present disclosure. Although FIG. 2 depicts steps performed in a particular order for purposes of illustration and discussion, the methods of the present disclosure are not limited to the particularly illustrated order or arrangement. The various steps of the method 200 can be omitted, rearranged, combined, and/or adapted in various ways without deviating from the scope of the present disclosure.

At 202, the computing system obtains a set of feature data that corresponds to one or more items. This feature data set comprises a plurality of values for each of a plurality of features. The feature data could be sourced from a single system or from multiple different production systems, each potentially having different data structures, vocabularies, and quality standards.

Following the acquisition of the feature data, at 204 the computing system establishes a multiplexed embedding table. This table is designed to support feature multiplexing, wherein at least two of the values, each associated with different features, are mapped to a shared vector in the embedding table. This mapping process could involve the use of a hash function, including a 2-universal hash function, which is permitted to generate inter-feature collisions, thereby allowing different feature values to map to the same vector in the table.

After the establishment of the multiplexed embedding table, at 206 the computing system proceeds to store a plurality of embeddings in the table. These embeddings are associated with the plurality of values in the feature data set. Each embedding represents a specific feature value as a continuous vector in a high-dimensional space. The embeddings are stored in the multiplexed embedding table, ready for retrieval and processing by a machine-learned model to generate predictions based on the feature data.

### Example Devices and Systems

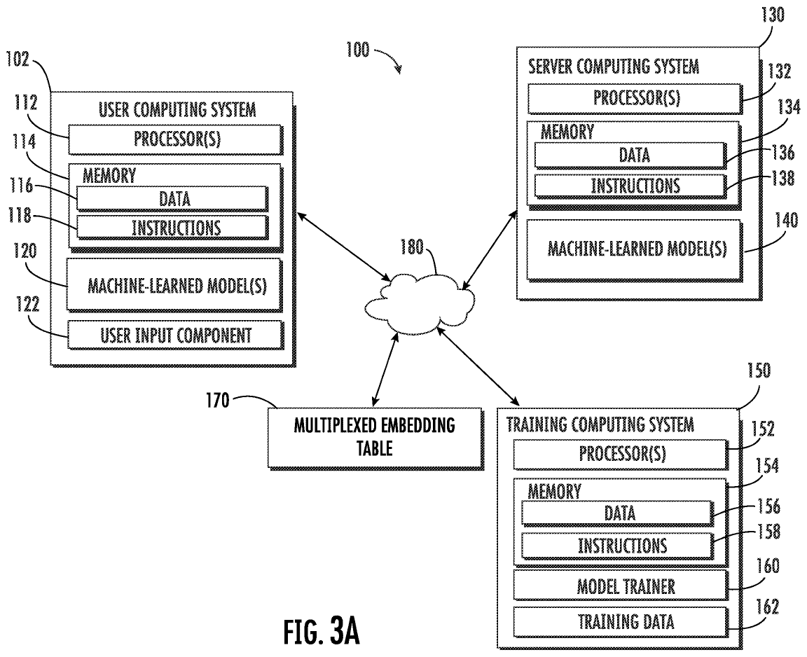

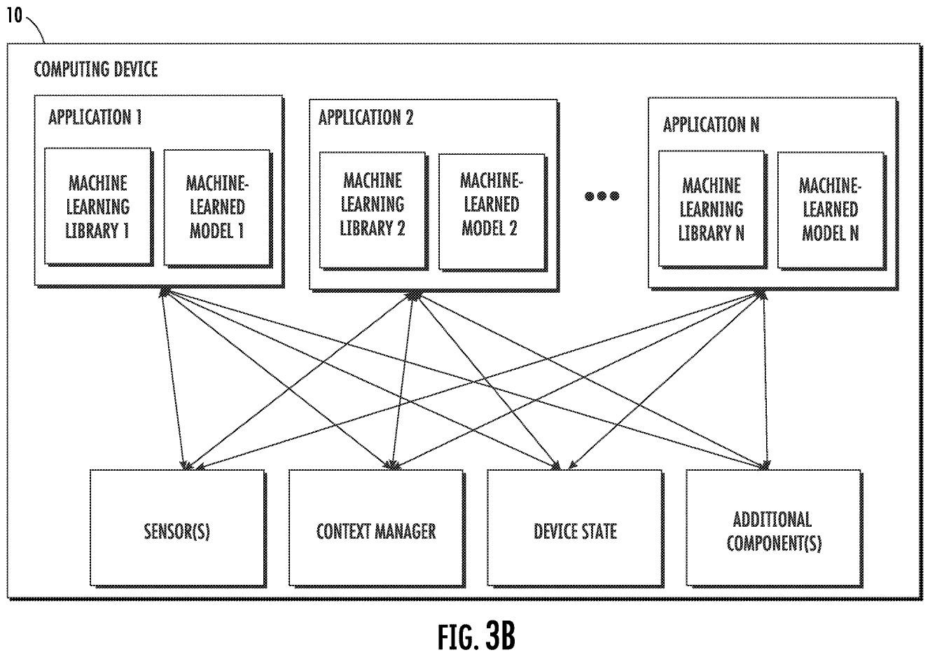

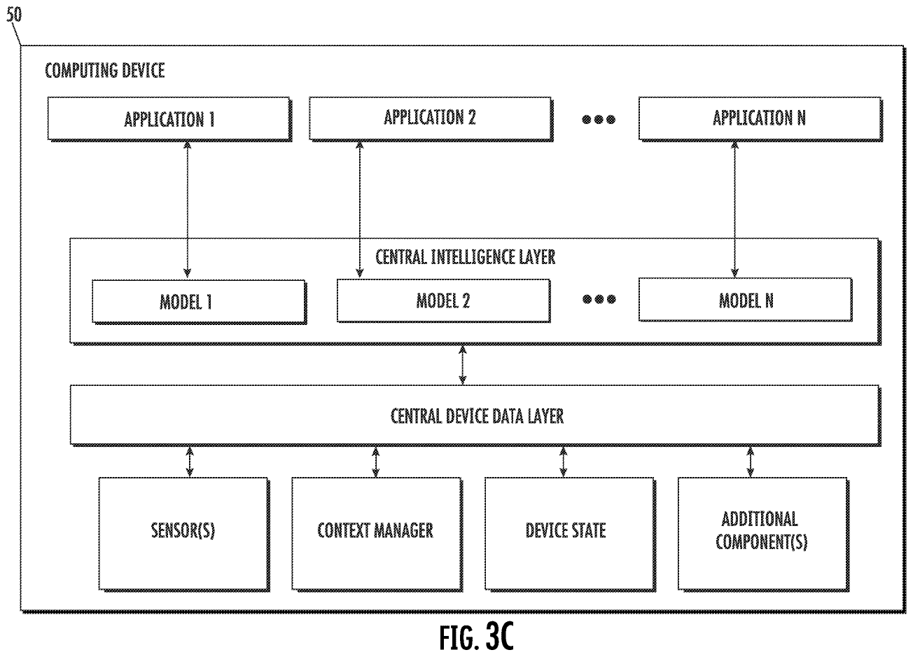

FIG. 3A depicts a block diagram of an example computing system 100 according to example embodiments of the present disclosure. The system 100 includes a user computing device 102, a server computing system 130, and a training computing system 150 that are communicatively coupled over a network 180. Some or all of the systems can include and/or be in operative communication with a multiplexed embedding table 170.

The user computing device 102 can be any type of computing device, such as, for example, a personal computing device (e.g., laptop or desktop), a mobile computing device (e.g., smartphone or tablet), a gaming console or controller, a wearable computing device, an embedded computing device, or any other type of computing device.

The user computing device 102 includes one or more processors 112 and a memory 114. The one or more processors 112 can be any suitable processing device (e.g., a processor core, a microprocessor, an ASIC, an FPGA, a controller, a microcontroller, etc.) and can be one processor or a plurality of processors that are operatively connected. The memory 114 can include one or more non-transitory computer-readable storage media, such as RAM, ROM, EEPROM, EPROM, flash memory devices, magnetic disks, etc., and combinations thereof. The memory 114 can store data 116 and instructions 118 which are executed by the processor 112 to cause the user computing device 102 to perform operations.

In some implementations, the user computing device 102 can store or include one or more machine-learned models 120. For example, the machine-learned models 120 can be or can otherwise include various machine-learned models such as neural networks (e.g., deep neural networks) or other types of machine-learned models, including non-linear models and/or linear models. Neural networks can include feed-forward neural networks, recurrent neural networks (e.g., long short-term memory recurrent neural networks), convolutional neural networks or other forms of neural networks. Some example machine-learned models can leverage an attention mechanism such as self-attention. For example, some example machine-learned models can include multi-headed self-attention models (e.g., transformer models).

In some implementations, the one or more machine-learned models 120 can be received from the server computing system 130 over network 180, stored in the user computing device memory 114, and then used or otherwise implemented by the one or more processors 112. In some implementations, the user computing device 102 can implement multiple parallel instances of a single machine-learned model 120.

Additionally or alternatively, one or more machine-learned models 140 can be included in or otherwise stored and implemented by the server computing system 130 that communicates with the user computing device 102 according to a client-server relationship. For example, the machine-learned models 140 can be implemented by the server computing system 140 as a portion of a web service. Thus, one or more models 120 can be stored and implemented at the user computing device 102 and/or one or more models 140 can be stored and implemented at the server computing system 130.

The user computing device 102 can also include one or more user input components 122 that receives user input. For example, the user input component 122 can be a touch-sensitive component (e.g., a touch-sensitive display screen or a touch pad) that is sensitive to the touch of a user input object (e.g., a finger or a stylus). The touch-sensitive component can serve to implement a virtual keyboard. Other example user input components include a microphone, a traditional keyboard, or other means by which a user can provide user input.

The server computing system 130 includes one or more processors 132 and a memory 134. The one or more processors 132 can be any suitable processing device (e.g., a processor core, a microprocessor, an ASIC, an FPGA, a controller, a microcontroller, etc.) and can be one processor or a plurality of processors that are operatively connected. The memory 134 can include one or more non-transitory computer-readable storage media, such as RAM, ROM, EEPROM, EPROM, flash memory devices, magnetic disks, etc., and combinations thereof. The memory 134 can store data 136 and instructions 138 which are executed by the processor 132 to cause the server computing system 130 to perform operations.

In some implementations, the server computing system 130 includes or is otherwise implemented by one or more server computing devices. In instances in which the server computing system 130 includes plural server computing devices, such server computing devices can operate according to sequential computing architectures, parallel computing architectures, or some combination thereof.

As described above, the server computing system 130 can store or otherwise include one or more machine-learned models 140. For example, the models 140 can be or can otherwise include various machine-learned models. Example machine-learned models include neural networks or other multi-layer non-linear models. Example neural networks include feed forward neural networks, deep neural networks, recurrent neural networks, and convolutional neural networks. Some example machine-learned models can leverage an attention mechanism such as self-attention. For example, some example machine-learned models can include multi-headed self-attention models (e.g., transformer models).

The user computing device 102 and/or the server computing system 130 can train the models 120 and/or 140 via interaction with the training computing system 150 that is communicatively coupled over the network 180. The training computing system 150 can be separate from the server computing system 130 or can be a portion of the server computing system 130.

The training computing system 150 includes one or more processors 152 and a memory 154. The one or more processors 152 can be any suitable processing device (e.g., a processor core, a microprocessor, an ASIC, an FPGA, a controller, a microcontroller, etc.) and can be one processor or a plurality of processors that are operatively connected. The memory 154 can include one or more non-transitory computer-readable storage media, such as RAM, ROM, EEPROM, EPROM, flash memory devices, magnetic disks, etc., and combinations thereof. The memory 154 can store data 156 and instructions 158 which are executed by the processor 152 to cause the training computing system 150 to perform operations. In some implementations, the training computing system 150 includes or is otherwise implemented by one or more server computing devices.

The training computing system 150 can include a model trainer 160 that trains the machine-learned models 120 and/or 140 stored at the user computing device 102 and/or the server computing system 130 using various training or learning techniques, such as, for example, backwards propagation of errors. For example, a loss function can be backpropagated through the model(s) to update one or more parameters of the model(s) (e.g., based on a gradient of the loss function). Various loss functions can be used such as mean squared error, likelihood loss, cross entropy loss, hinge loss, and/or various other loss functions. Gradient descent techniques can be used to iteratively update the parameters over a number of training iterations.

In some implementations, performing backwards propagation of errors can include performing truncated backpropagation through time. The model trainer 160 can perform a number of generalization techniques (e.g., weight decays, dropouts, etc.) to improve the generalization capability of the models being trained.

In particular, the model trainer 160 can train the machine-learned models 120 and/or 140 based on a set of training data 162. The training data 162 can include, for example, feature data. In some implementations, if the user has provided consent, the training examples can be provided by the user computing device 102. Thus, in such implementations, the model 120 provided to the user computing device 102 can be trained by the training computing system 150 on user-specific data received from the user computing device 102. In some instances, this process can be referred to as personalizing the model.

In some implementations, for example as part of training models 120 and/or 140, the model trainer 160 can establish and/or use the multiplexed embedding table 170. For example, a database system can be provided. This system could be a relational database such as PostgreSQL or MySQL, or a NoSQL database such as MongoDB. The system can be configured to store the embedding table 170 that can include columns for an identifier (id), a vector representation, and potentially additional metadata such as creation_date. The mapping between items and vectors (e.g., rows) in the embedding table 170 can be generated and maintained as described herein.

An embedding model can be trained using a dataset. This can be accomplished using algorithms which are capable of generating a high-dimensional vector for each unique item or entity (e.g., word) in the dataset, though some vectors may be shared by multiple items, as described herein. The generated vectors can capture the semantic meaning of each item or entity. The generated embeddings can be stored in the embedding table 170 stored in the database. This can be performed using a database management library or an Object-Relational Mapping (ORM) tool. Each unique item and its corresponding vector can be inserted into the embedding table 170 in the database. The computing system 100 can retrieve the stored embeddings from the database when required by an application. This can include querying the database for a specific entity's vector.

Additionally, the computing system can update the existing embeddings in the database. This can occur when the embedding model is retrained and new vectors are generated. As one example, an SQL UPDATE statement can be used to replace the old vector of an entity with the new vector. The proposed table 170 can also be expanded to include considerations for large-scale or high-performance applications. Techniques such as quantization or other forms of vector compression can be implemented to reduce the storage and computational costs. For fast similarity search, approximate nearest neighbor (ANN) search methods or specific libraries (e.g., FAISS) can be used.

The model trainer 160 includes computer logic utilized to provide desired functionality. The model trainer 160 can be implemented in hardware, firmware, and/or software controlling a general purpose processor. For example, in some implementations, the model trainer 160 includes program files stored on a storage device, loaded into a memory and executed by one or more processors. In other implementations, the model trainer 160 includes one or more sets of computer-executable instructions that are stored in a tangible computer-readable storage medium such as RAM, hard disk, or optical or magnetic media.

The network 180 can be any type of communications network, such as a local area network (e.g., intranet), wide area network (e.g., Internet), or some combination thereof and can include any number of wired or wireless links. In general, communication over the network 180 can be carried via any type of wired and/or wireless connection, using a wide variety of communication protocols (e.g., TCP/IP, HTTP, SMTP, FTP), encodings or formats (e.g., HTML, XML), and/or protection schemes (e.g., VPN, secure HTTP, SSL).

The machine-learned models described in this specification may be used in a variety of tasks, applications, and/or use cases.

In some implementations, the input to the machine-learned model(s) of the present disclosure can be image data. The machine-learned model(s) can process the image data to generate an output. As an example, the machine-learned model(s) can process the image data to generate an image recognition output (e.g., a recognition of the image data, a latent embedding of the image data, an encoded representation of the image data, a hash of the image data, etc.). As another example, the machine-learned model(s) can process the image data to generate an image segmentation output. As another example, the machine-learned model(s) can process the image data to generate an image classification output. As another example, the machine-learned model(s) can process the image data to generate an image data modification output (e.g., an alteration of the image data, etc.). As another example, the machine-learned model(s) can process the image data to generate an encoded image data output (e.g., an encoded and/or compressed representation of the image data, etc.). As another example, the machine-learned model(s) can process the image data to generate an upscaled image data output. As another example, the machine-learned model(s) can process the image data to generate a prediction output.

In some implementations, the input to the machine-learned model(s) of the present disclosure can be text or natural language data. The machine-learned model(s) can process the text or natural language data to generate an output. As an example, the machine-learned model(s) can process the natural language data to generate a language encoding output. As another example, the machine-learned model(s) can process the text or natural language data to generate a latent text embedding output. As another example, the machine-learned model(s) can process the text or natural language data to generate a translation output. As another example, the machine-learned model(s) can process the text or natural language data to generate a classification output. As another example, the machine-learned model(s) can process the text or natural language data to generate a textual segmentation output. As another example, the machine-learned model(s) can process the text or natural language data to generate a semantic intent output. As another example, the machine-learned model(s) can process the text or natural language data to generate an upscaled text or natural language output (e.g., text or natural language data that is higher quality than the input text or natural language, etc.). As another example, the machine-learned model(s) can process the text or natural language data to generate a prediction output.

In some implementations, the input to the machine-learned model(s) of the present disclosure can be speech data. The machine-learned model(s) can process the speech data to generate an output. As an example, the machine-learned model(s) can process the speech data to generate a speech recognition output. As another example, the machine-learned model(s) can process the speech data to generate a speech translation output. As another example, the machine-learned model(s) can process the speech data to generate a latent embedding output. As another example, the machine-learned model(s) can process the speech data to generate an encoded speech output (e.g., an encoded and/or compressed representation of the speech data, etc.). As another example, the machine-learned model(s) can process the speech data to generate an upscaled speech output (e.g., speech data that is higher quality than the input speech data, etc.). As another example, the machine-learned model(s) can process the speech data to generate a textual representation output (e.g., a textual representation of the input speech data, etc.). As another example, the machine-learned model(s) can process the speech data to generate a prediction output.

In some implementations, the input to the machine-learned model(s) of the present disclosure can be latent encoding data (e.g., a latent space representation of an input, etc.). The machine-learned model(s) can process the latent encoding data to generate an output. As an example, the machine-learned model(s) can process the latent encoding data to generate a recognition output. As another example, the machine-learned model(s) can process the latent encoding data to generate a reconstruction output. As another example, the machine-learned model(s) can process the latent encoding data to generate a search output. As another example, the machine-learned model(s) can process the latent encoding data to generate a reclustering output. As another example, the machine-learned model(s) can process the latent encoding data to generate a prediction output.

In some implementations, the input to the machine-learned model(s) of the present disclosure can be statistical data. Statistical data can be, represent, or otherwise include data computed and/or calculated from some other data source. The machine-learned model(s) can process the statistical data to generate an output. As an example, the machine-learned model(s) can process the statistical data to generate a recognition output. As another example, the machine-learned model(s) can process the statistical data to generate a prediction output. As another example, the machine-learned model(s) can process the statistical data to generate a classification output. As another example, the machine-learned model(s) can process the statistical data to generate a segmentation output. As another example, the machine-learned model(s) can process the statistical data to generate a visualization output. As another example, the machine-learned model(s) can process the statistical data to generate a diagnostic output.

In some implementations, the input to the machine-learned model(s) of the present disclosure can be sensor data. The machine-learned model(s) can process the sensor data to generate an output. As an example, the machine-learned model(s) can process the sensor data to generate a recognition output. As another example, the machine-learned model(s) can process the sensor data to generate a prediction output. As another example, the machine-learned model(s) can process the sensor data to generate a classification output. As another example, the machine-learned model(s) can process the sensor data to generate a segmentation output. As another example, the machine-learned model(s) can process the sensor data to generate a visualization output. As another example, the machine-learned model(s) can process the sensor data to generate a diagnostic output. As another example, the machine-learned model(s) can process the sensor data to generate a detection output.

In some cases, the machine-learned model(s) can be configured to perform a task that includes encoding input data for reliable and/or efficient transmission or storage (and/or corresponding decoding). For example, the task may be an audio compression task. The input may include audio data and the output may comprise compressed audio data. In another example, the input includes visual data (e.g. one or more images or videos), the output comprises compressed visual data, and the task is a visual data compression task. In another example, the task may comprise generating an embedding for input data (e.g. input audio or visual data).

In some cases, the input includes visual data and the task is a computer vision task. In some cases, the input includes pixel data for one or more images and the task is an image processing task. For example, the image processing task can be image classification, where the output is a set of scores, each score corresponding to a different object class and representing the likelihood that the one or more images depict an object belonging to the object class. The image processing task may be object detection, where the image processing output identifies one or more regions in the one or more images and, for each region, a likelihood that region depicts an object of interest. As another example, the image processing task can be image segmentation, where the image processing output defines, for each pixel in the one or more images, a respective likelihood for each category in a predetermined set of categories. For example, the set of categories can be foreground and background. As another example, the set of categories can be object classes. As another example, the image processing task can be depth estimation, where the image processing output defines, for each pixel in the one or more images, a respective depth value. As another example, the image processing task can be motion estimation, where the network input includes multiple images, and the image processing output defines, for each pixel of one of the input images, a motion of the scene depicted at the pixel between the images in the network input.

In some cases, the input includes audio data representing a spoken utterance and the task is a speech recognition task. The output may comprise a text output which is mapped to the spoken utterance. In some cases, the task comprises encrypting or decrypting input data. In some cases, the task comprises a microprocessor performance task, such as branch prediction or memory address translation.

FIG. 3A illustrates one example computing system that can be used to implement the present disclosure. Other computing systems can be used as well. For example, in some implementations, the user computing device 102 can include the model trainer 160 and the training dataset 162. In such implementations, the models 120 can be both trained and used locally at the user computing device 102. In some of such implementations, the user computing device 102 can implement the model trainer 160 to personalize the models 120 based on user-specific data.

FIG. 3B depicts a block diagram of an example computing device 10 that performs according to example embodiments of the present disclosure. The computing device 10 can be a user computing device or a server computing device.

The computing device 10 includes a number of applications (e.g., applications 1 through N). Each application contains its own machine learning library and machine-learned model(s). For example, each application can include a machine-learned model. Example applications include a text messaging application, an email application, a dictation application, a virtual keyboard application, a browser application, etc.

As illustrated in FIG. 3B, each application can communicate with a number of other components of the computing device, such as, for example, one or more sensors, a context manager, a device state component, and/or additional components. In some implementations, each application can communicate with each device component using an API (e.g., a public API). In some implementations, the API used by each application is specific to that application.

FIG. 3C depicts a block diagram of an example computing device 50 that performs according to example embodiments of the present disclosure. The computing device 50 can be a user computing device or a server computing device.

The computing device 50 includes a number of applications (e.g., applications 1 through N). Each application is in communication with a central intelligence layer. Example applications include a text messaging application, an email application, a dictation application, a virtual keyboard application, a browser application, etc. In some implementations, each application can communicate with the central intelligence layer (and model(s) stored therein) using an API (e.g., a common API across all applications).

The central intelligence layer includes a number of machine-learned models. For example, as illustrated in FIG. 3C, a respective machine-learned model can be provided for each application and managed by the central intelligence layer. In other implementations, two or more applications can share a single machine-learned model. For example, in some implementations, the central intelligence layer can provide a single model for all of the applications. In some implementations, the central intelligence layer is included within or otherwise implemented by an operating system of the computing device 50.

The central intelligence layer can communicate with a central device data layer. The central device data layer can be a centralized repository of data for the computing device 50. As illustrated in FIG. 3C, the central device data layer can communicate with a number of other components of the computing device, such as, for example, one or more sensors, a context manager, a device state component, and/or additional components. In some implementations, the central device data layer can communicate with each device component using an API (e.g., a private API).

### Additional Disclosure

The technology discussed herein makes reference to servers, databases, software applications, and other computer-based systems, as well as actions taken and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations and/or additions to the present subject matter as would be readily apparent to one of ordinary skill in the art. For instance, features illustrated or described as part of one embodiment can be used with another embodiment to yield a still further embodiment. Thus, it is intended that the present disclosure cover such alterations, variations, and equivalents.

1. A computer-implemented method to generate embedding tables with improved computational efficiency, the method comprising:
obtaining, by a computing system comprising one or more computing devices, a set of feature data that corresponds to one or more items, wherein the set of feature data comprises a plurality of values for each of a plurality of features;
establishing, by the computing system, a multiplexed embedding table in which at least two of the values that are respectively associated with at least two different features of the plurality of features are mapped to a shared vector in the multiplexed embedding table; and
storing, by the computing system, a plurality of embeddings associated with the plurality of values in the multiplexed embedding table.

2. The computer-implemented method of claim 1, wherein the shared vector comprises a shared row.

3. The computer-implemented method of claim 1, wherein establishing, by the computing system, the multiplexed embedding table comprises using a hash function to map the plurality of values for each feature to vectors of the multiplexed embedding table, and wherein the hash function is permitted to generate inter-feature collisions.

4. The computer-implemented method of claim 3, wherein the hash function comprises a 2-universal hash function.

5. The computer-implemented method of claim 3, wherein a different hash function is used for each feature.

6. The computer-implemented method of claim 3, wherein a same hash function is used for at least two of the features.

7. The computer-implemented method of claim 1, wherein a first value for a first feature of the plurality of features is mapped to a different number of vectors in the multiplexed embedding table than a second value for a second feature of the plurality of features.

8. The computer-implemented method of claim 1, wherein a first value for a first feature of the plurality of features is mapped to multiple vectors in the multiplexed embedding table, and wherein retrieving a first embedding associated with the first value comprises concatenating the embedding values stored in the multiple vectors.

9. The computer-implemented method of claim 1, wherein the feature data comprises multiple subsets of feature data associated with multiple different production systems.

10. One or more non-transitory computer-readable media that store a multiplexed embedding table, wherein the multiplexed embedding table was generated by the performance of operations comprising:
obtaining, by a computing system comprising one or more computing devices, a set of feature data that corresponds to one or more items, wherein the set of feature data comprises a plurality of values for each of a plurality of features;
establishing, by the computing system, the multiplexed embedding table in which at least two of the values that are respectively associated with at least two different features of the plurality of features are mapped to a shared vector in the multiplexed embedding table; and
storing, by the computing system, a plurality of embeddings associated with the plurality of values in the multiplexed embedding table.

11. A computing system comprising:
one or more processors; and
one or more non-transitory computer-readable media that collectively store:
a machine-learned model; and
instructions that, when executed by the one or more processors, cause the computing system to perform operations, the operations comprising:
retrieving, by the computing system, an embedding from a multiplexed embedding table in which at least two values that are respectively associated with at least two different features of a plurality of features are mapped to a shared vector in the multiplexed embedding table;
processing, by the computing system, the embedding with the machine-learned model to generate, as an output of the machine-learned model, a prediction; and
providing, by the computing system, the prediction as an output.
